(19) United States
(12) Patent Application Publication
(10) Pub. No.: US 2025/0292439 A1
(43) Pub. Date: Sep. 18, 2025

(54) METHOD AND CONTROL UNIT FOR PROCESSING SENSOR DATA

(71) Applicant: Robert Bosch GmbH, Stuttgart (DE)

(72) Inventors: Claudius Glaeser, Ditzingen (DE); Daniel Niederloehner, Stuttgart (DE); Florian Faion, Staufen (DE); Jiaying Lin, Magstadt (DE); Karim Adel Dawood Armanious, Stuttgart (DE); Marcel Schreiber, Neu-Ulm (DE); Maurice Quach, Ditzingen (DE); Michael Ulrich, Stuttgart (DE); Ruediger Jordan, Stuttgart (DE); Sascha Braun, Eningen Unter Achalm (DE)

(21) Appl. No.: 19/064,790

(22) Filed: Feb. 27, 2025

(30) Foreign Application Priority Data
Mar. 13, 2024 (DE) 10 2024 202 336.1

(51) Int. Cl. G06T 9/00; G06T 3/40; G06T 7/33; G06T 11/00

(52) U.S. Cl. CPC G06T 9/00; G06T 3/40; G06T 7/33; G06T 11/00; G06T 2207/10028; G06T 2210/56

(57) ABSTRACT

A method for processing sensor data, wherein the sensor data are present as a point cloud of individual points. The points are projected into at least two rasters with different resolutions. Points from a subregion of the point cloud are projected into a first raster with higher resolution and further points of the point cloud are projected into a second raster with lower resolution. Attributes from the first raster are compressed and arranged in the second raster before the attributes from the second raster are compressed.

### CROSS REFERENCE

The present application claims the benefit under 35 U.S.C. § 119 of German Patent Application No. DE 10 2024 202 336.1 filed on Mar. 13, 2024, which is expressly incorporated herein by reference in its entirety.

### FIELD

The present invention relates to a method for processing sensor data, to a corresponding control unit and to a corresponding computer program product.

### BACKGROUND INFORMATION

A point cloud from a sensor can be rasterized, i.e., projected into cells of a raster. For object recognition, the raster can be compressed by a neural network in a plurality of stages until it becomes a bottleneck for information. After the bottleneck, objects can be searched in the compressed information, found, classified and labeled.

Depending on the local point density of the point cloud, many cells of the raster remain empty during the projection, while a plurality of points are projected into other cells.

### SUMMARY

The present invention provides a method for processing sensor data, a corresponding control unit, and a corresponding computer program product. Advantageous developments, example embodiments, and improvements of the present invention are disclosed herein.

The present invention uses rasters with different extents and different cell densities to accommodate the points of a point cloud during the projection. In regions with a high point density, a small-scale raster with small cells is used locally. Regions with low point density are projected into at least one large-scale raster with large cells. The small-scale raster is then compressed in a compression stage of a neural network and subsequently inserted into the larger raster with larger cells at the appropriate location. The larger raster with the inserted compressed smaller raster is then compressed in the next compression stage of the neural network and in turn inserted into a larger raster with larger cells. This process is continued until a predefined compression is achieved. Then, the compressed information is searched for objects in the conventional way.

The approach according to the present invention can save memory space and computing power, since only regions of the point cloud with a high point density, i.e., a high specific information content, pass through a plurality of compression stages of the neural network. With each compression, a memory requirement decreases, since the entire point cloud is not stored in each compression stage. Since only subregions of the point cloud have a high point density, the rasters to be compressed are smaller than the entire point cloud. As a result, limited computing power is required. Only in one of the last compression stages are the last remaining points and thus the entire point cloud compressed.

Additionally, information can be lost at any compression stage. This is less relevant in regions of the point cloud with many points and thus a lot of information than in regions with few points and thus little information. In regions with little information, the little information can be preserved better by reducing the number of compression stages.

According to an example embodiment of the present invention, a method for processing sensor data is provided, wherein the sensor data are present as a point cloud of individual points, wherein the points are projected into at least two (two-dimensional) rasters with different resolutions, wherein points from a subregion of the point cloud are projected into a first raster with higher resolution and further points of the point cloud are projected into a second raster with lower resolution, wherein attributes from the first raster are compressed and arranged in the second raster before the attributes from the second raster are compressed.

Ideas for embodiments of the present invention may be considered, inter alia, as being based on the concepts and findings described below.

A point cloud can be provided, for example, by a radar sensor or a lidar sensor. The point cloud consists of individual points with coordinates and attributes. For example, each point can represent a received reflection of the relevant sensor. A possible attribute of a point can be, for example, a relative velocity of the point to the sensor.

The sensor can be assumed to be point-shaped. Then, for a given maximum physical resolution of the sensor, a theoretically possible point density decreases with the cube of a distance to the sensor. The resulting point cloud thus has a strongly decreasing point density with increasing distance. In composite point clouds of a plurality of different sensors, regions with a high point density can be arranged at a plurality of locations.

When projecting the point cloud into a raster with cells of constant size, many points with a short distance to the sensor are projected into a single cell and/or many cells between cells into which a point with a large distance to the sensor is projected remain empty.

Cells of different sizes are used here. Additionally, rasters of different sizes are used, each covering regions of different sizes of the point cloud.

Only a small region of the point cloud at a short distance to the sensor theoretically has a high point density. In fact, there may be few or no points in some regions close to the sensor if, for example, there are no reflective objects there. This small region is projected into a raster that is just large enough to substantially cover only this region. This raster has a high resolution, i.e., small cells, so that as few points as possible are projected into the same cell.

According to an example embodiment of the present invention, this first raster is in particular compressed in a neural network, or information contained in the raster, i.e., the coordinates and attributes of the points, is condensed. This reduces a data volume. For example, neighboring cells of the raster are consolidated using rules. The compressed information can then have a reduced resolution.

The compressed information is then inserted into the next raster at the appropriate location. The next raster has a lower resolution than the first raster. The cells of the next raster are larger than the cells of the first raster. The next raster has a larger extent than the first raster. The region of the point cloud covered by the first raster is included in the coverage of the next raster. For example, the region of the point cloud covered by the first raster can be located at or close to an edge of the next raster.

The points of the point cloud covered by the next raster have been projected into the cells of the next raster. The next raster thus again contains positions and attributes of points of the point cloud. Points in the region of the first raster can be projected again into the next raster. The compressed attributes of the first raster are inserted into the next raster in the region of the first raster.

According to an example embodiment of the present invention, subsequently, the next raster is also compressed, in particular in the neural network, or the information contained in the next raster, i.e., the coordinates and attributes of the points, is condensed. The data volume is again reduced, for example by consolidating neighboring cells of the raster using rules. The compressed information can then again have a reduced resolution.

This process is repeated until the entire point cloud or at least a predefined portion of the point cloud has been projected into a last raster with a lowest resolution, the previous compressed raster has been inserted and the last raster has also been compressed.

Object recognition can subsequently be performed in the compressed attributes.

The compressed attributes from the previous raster can be aligned to the next raster before they are arranged in the next raster. The cells of the next raster can be aligned differently than the cells of the previous raster. For example, the cells can be twisted and/or shifted. A coordinate transformation can then be performed for alignment. Alignment allows an original spatial relationship between the points projected in the different rasters to be maintained.

According to an example embodiment of the present invention, the compressed attributes from the previous raster can be scaled to the resolution of the next raster before they are arranged in the next raster. The compressed attributes may still have a higher or lower resolution than the cells of the next raster. The compressed attributes can then be stretched or compressed, for example, until they fit the cells of the next raster.

The points of the subregion can also be projected into the next raster. When arranging the compressed attributes from the first raster in the next raster, they can be combined with the uncompressed attributes of the points from the subregion that are already present in the next raster. The attributes can, for example, be merged. As a result, the uncompressed information is not lost. Each cell can be described by a vector with a predefined length. During the combining, the length of the vector can be maintained.

According to an example embodiment of the present invention, during the compression, the attributes from the previous raster can be compressed to the resolution of the next raster. The compression stage of the neural network can be configured to output the appropriate resolution. By using an appropriate resolution, the attributes of the previous raster can be easily integrated into the next raster.

According to an example embodiment of the present invention, during the projection, attributes of a plurality of points can be combined if the a plurality of points are projected into a common cell of the relevant raster. The attributes can be combined into a vector with a defined length. Empty cells can be filled with a predefined blank vector in order to simplify compression.

Points arranged in a near range can be projected into the first raster. Points arranged in a far range can be projected into a larger raster. Points arranged in a mid-range can be projected into a medium raster.

Further points of the point cloud can be projected into a further raster with lower resolution. Attributes from the second raster can be compressed into second compressed attributes and arranged in the further raster before the attributes from the further raster are compressed.

The method is preferably computer-implemented and can be implemented, for example, in software or hardware or in a mixed form of software and hardware, for example in a driver assistance system.

The present invention furthermore provides a control unit in the form of a driver assistance system for a vehicle, wherein the driver assistance system is designed to carry out, control or implement, in corresponding apparatuses, the steps of a variant of the method according to the present invention presented here.

The control unit or driver assistance system can be an electrical device having at least one computing unit for processing signals or data, at least one memory unit for storing signals or data, and at least one interface and/or one communication interface for reading in or outputting data embedded in a communication protocol. The computing unit can, for example, be a signal processor, a so-called system ASIC, or a microcontroller for processing sensor signals and outputting data signals depending on the sensor signals. The memory unit can, for example, be a flash memory, an EPROM, or a magnetic memory unit. The interface can be designed as a sensor interface for reading in the sensor signals from a sensor and/or as an actuator interface for outputting the data signals and/or control signals to an actuator. The communication interface can be designed to read in or output the data in a wireless and/or wired manner. The interfaces may also be software modules that are present, for example, on a microcontroller in addition to other software modules.

A computer program product or a computer program having program code that can be stored on a machine-readable carrier or storage medium, such as a semiconductor memory, a hard disk memory, or an optical memory, and that is used for carrying out, implementing, and/or controlling the steps of the method according to one of the embodiments of the present invention described herein, in particular when the program product or program is executed on a computer or a device, is advantageous as well.

It is pointed out that some of the possible features and advantages of the present invention are described herein with reference to different embodiments. A person skilled in the art recognizes that the features of the control unit and of the method can be suitably combined, adapted or replaced in order to arrive at further embodiments of the present invention.

### BRIEF DESCRIPTION OF THE DRAWINGS

Example embodiments of the present invention are described below with reference to the FIGURES, and neither the FIGURES nor the description should be construed as limiting the present invention.

FIG. 1 shows a block diagram of a method according to an exemplary embodiment of the present invention.

The FIGURE is merely schematic and not true to scale. Identical reference signs refer to identical or identically acting features.

### DETAILED DESCRIPTION OF EXAMPLE EMBODIMENTS

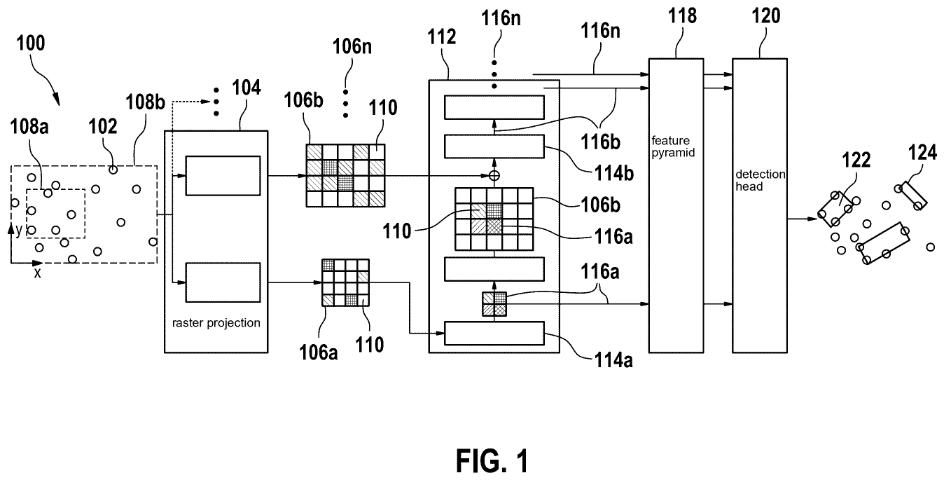

FIG. 1 shows a block diagram of a method according to an exemplary embodiment. A point cloud 100 is provided by a sensor, such as a radar sensor or a lidar sensor. The point cloud 100 consists of individual points 102, each of which has coordinates and at least one attribute. Here, the points 102 are shown in two dimensions x and y, but they can also be spatial.

The point cloud 100 is projected in a raster projection 104 into different rasters 106. Here, for simplified explanation, the point cloud 100 is only projected into two different rasters 106a and 106b. However, the point cloud 100 can be projected into a plurality of different rasters 106.

In the example, a first subregion 108a of the point cloud 100 is projected into the first raster 106a. The first subregion 108a comprises a portion of the point cloud 100 with a high point density. The first raster 106a has a high resolution with a limited extent. The extent substantially corresponds to a size of the first subregion 108a. Cells 110 of the first raster 106a are small and arranged close to one another. Due to the small, densely arranged cells 110, few points 102 are projected per cell 110. The attributes of the points 102 projected together into a cell 110 are consolidated.

A second subregion 108b of the point cloud 100 is projected into a second raster 106b. The second subregion 108b is larger than the first subregion 108a and completely comprises the first subregion 108a. In other words, the first subregion 108a lies within the second subregion 108b. Here, for the sake of simplicity, the second subregion 108b comprises the entire point cloud 100. However, the second subregion 108b can also be only slightly larger than the first subregion 108a. The second raster 106b has a lower resolution than the first raster 106a. The cells 110 of the second raster 106b are therefore larger and arranged further apart than the cells 110 of the first raster 106a. All points 102 of the first subregion 108a are thus projected again into cells 110 of the second raster 106b. At least in the first subregion 108a, more points 102 are projected into a common cell 110 than during the first projection. In regions of the point cloud 100 with a lower point density, only a few points 102 are again projected together into a cell 110 of the second raster 106b.

In one exemplary embodiment of the present invention, the first subregion 108a covers a near range in front of the sensor, while the second subregion 108b covers the near range and a far range.

After the raster projection 104, the rasters 106 filled with the attributes are processed in, for example, a convolutional neural network 112. In a first processing stage 114a, the attributes from the first raster 106a are compressed into first compressed attributes 116a. The first compressed attributes 116a are then inserted into the second raster 106b. The first compressed attributes 116a are inserted into the cells 110 of the second raster 106b that correspond to the first subregion 108a. Uncompressed attributes already present in these cells 110 are merged with the compressed attributes 116a.

In a second processing stage 114b, the attributes from the second raster 106b are compressed into second compressed attributes 116b. The first compressed attributes 116a with the merged attributes are compressed again. This process is repeated until at least a predefined portion of the point cloud 100 is compressed to a predefined compression level.

The compressed attributes 116 are subsequently arranged, for example, in a feature pyramid 118. Then, objects 122 are recognized in the feature pyramid 118 by, for example, a detection head 120 and marked, for example, by bounding boxes 124.

In one exemplary embodiment, after the relevant processing stage 114, the compressed attributes 116 are adjusted to the next coarser raster 106 of the next processing stage 114. For this purpose, the compressed attributes 116 are, for example, aligned and/or scaled.

Possible embodiments of the present invention are summarized again below or described using slightly different words.

A method for range adjustment in multiscale neural networks for object recognition using point clouds is presented.

Advanced driver assistance systems (ADAS) and autonomous driving (AD) require an accurate representation of the vehicle's environment. Many perception sensors, such as LiDAR and radar, represent the distant objects in the environment with a set of points, which is called a point cloud. Usually, each point represents the three-dimensional position (x, y, z) of the reflection and other features such as intensity and measurement quality.

During object recognition from the point cloud, deep neural networks (DNNs) can recognize patterns of the points and represent the possible objects in the environment by a list of oriented bounding boxes with existence probability and object classes. The deep neural networks must be trained with sufficiently labeled data collected in different scenarios. Grid-based deep neural networks are one of the most commonly used models for object recognition. These methods are inspired by image processing, extracting features from each pixel and learning the connections between the pixels, for example using convolutional neural networks (CNNs). In order to obtain image-like feature maps, the point cloud is first projected into a predefined raster. A position in the raster depends on the position of the points. Starting from the bird's eye view (BEV) grid map on the xy plane, the region and the grid resolution of the bird's eye view grid map are first defined; then, the points are assigned to the corresponding grid cells according to their position on the xy plane. The attributes of each grid cell are determined by all points within that cell and are then fed into the further layers of the deep neural network, e.g., the convolutional backbone. The convolutional backbone generally consists of a plurality of stages that process the input at different scales. The outputs of the stages are combined into a feature pyramid, which is then processed in the feature pyramid network and the detection head for further pattern recognition or bounding box extraction.

Grid-based object recognition methods using LiDAR point clouds have been studied extensively. Grid-based deep neural networks such as PointNet, PointNet++ and PointPillars have achieved promising recognition performance in various benchmarks. On the basis of the successful examples for LiDAR recognition, these architectures have been adapted for radar point clouds in a plurality of studies. Due to the low density of radar points, the attributes of the points can be weakened by a plurality of stages in the convolutional backbone, resulting in reduced recognition performance. In addition, grid-based methods generally suffer from high computational effort, in particular during far-range detection, in which a long-range, high-resolution grid map is defined.

In order to improve recognition performance, it is proposed to project the point cloud onto a plurality of grid maps with different grid cell sizes. The point clouds are projected onto raster maps with predefined ranges, but different raster resolutions. The generated feature maps are used in backbone stages with corresponding scales. In this way, the different stages in the backbone benefit from the direct extraction of information from the point cloud, without it being lost in the pyramid structure. The architecture with a plurality of raster maps as input therefore outperforms that with a single raster map as input in terms of recognition accuracy. However, this approach does not solve the problem of computational complexity. Instead, more computing time and memory space are required for storing and processing the multiscale grid projections.

In the context of grid-based deep neural network object recognition using the point cloud, the approach presented here aims to solve the problem of computational complexity of multiscale grid projections. It adjusts the range of each grid projection on the basis of the point density. Only nearby points are projected onto grids with high resolution and processed, while the more distant points are projected onto larger grid maps with lower resolution. In this way, the computational complexity can be reduced. since only the nearby points are processed at high resolution in the early stages, while the more distant points are processed at low resolution in the later stages.

The input of the object recognition network for object recognition with deep neural networks is a set of unordered points in n dimensions. Each point is characterized by its position and other properties, such as the reflection intensity in the case of LiDAR or the radial velocity in the case of radar. In order to process the point cloud, raster maps with different ranges and resolutions are defined first, and the point cloud is projected into these raster maps, generating multi-range feature maps. These feature maps are simultaneously fed into the convolutional backbone. In the convolutional backbone, grid alignment methods are used to align the ranges from different stages. After the feature pyramid network module and detection head module, the output of the network is a list of oriented bounding boxes, each of which surrounds a possible object and contains information about the object type, the position and the dimensions (length, width, height, orientation).

Experiments show that the approach reduces the computational complexity in terms of GPU runtime and memory space, while maintaining similar recognition accuracy in comparison to the conventional methods. More specifically, this approach can reduce the computer's memory requirement. As a result of adjusting the ranges, only rasters within a smaller range are used in the initial phase. In comparison to the conventional methods, which use constant full ranges in each phase, this approach avoids the unnecessary recognition of large regions in the early backbone phases and thus saves the required memory space. In addition, the presented approach can reduce the processing time. Since only small-scale grid maps are processed in the early phases, the computing time for the convolution operations on distant grids in the early backbone phases can be saved. The presented approach also makes high-resolution object detection possible. Adjusting the distances makes high-resolution recognition possible in the smaller distance rasters, while keeping the computational load low. The accuracy of the recognition is also maintained. Thanks to the multiscale grid projections, the recognition accuracy of this method can be kept high even if only small-scale grid maps are used at the beginning.

The proposed approach offers great advantages and can be used for a large number of products.

FIG. 1 shows an exemplary block diagram of the proposed approach using the example of a two-dimensional grid projection, which adjusts the ranges of the grid projections and aligns them in the backbone networks. The input to the range adjustment module is the same as that of the network: a set of n-dimensional unordered points. This module outputs a plurality of n-dimensional feature maps with different ranges [xmini, xmaxi, ymini, ymaxi, . . . ]. Here, xmin, xmax, ymin, ymax denote the ranges, and i denotes the i-th feature map, which is then merged in corresponding processing stages in the convolutional backbone.

In order to generate these feature maps, the range adjustment module first defines the required ranges [xmini, xmaxi, ymini, ymaxi, . . . ] and grid sizes [csxi, csyi] on the basis of prior experimental knowledge. For example, the entire perception range can be divided into short-range and long-range regions on the basis of the point locations. The point cloud is subsequently projected onto the grid maps with the predefined ranges and grid cell sizes. If a raster cell contains a point, its attributes are transferred to the raster cell. If a plurality of points fall into a raster cell, their attributes are aggregated, e.g., by means of a pooling function or a PointNet, in which a pillar feature network is used to project the point-aggregated features into the bird's eye view raster map. For this purpose, all points in a grid cell are consolidated into pillars. The features of each point are embedded individually by a fully connected neural network. In the event of a plurality of points falling into the same column, mean pooling is applied over all points within the column in order to obtain a feature vector with a fixed length.

The multi-stage raster maps with the features generated by the pillar feature network are subsequently fed into the corresponding processing stages of the convolutional backbone, which uses a convolutional neural network to process the data at a plurality of spatial scales and ranges. Each processing stage generates a feature map with the same range as the input. In order to align the feature maps in the different phases, a grid alignment module is arranged between each processing phase. For example, feature map A in a small range has a range of [xmin1, xmax1, ymin1, ymax1] with grid cell size [csx1, csy1]. Feature map B in the large range has a range of [xmin2, xmax2, ymin2, ymax2] with raster cell size [csx2, csy2]. The size of the grid cells depends on the processing stage of the backbone. Since the first processing stage in the convolutional backbone accepts the grid map in a small range as input, it generates a feature map C with the range [xmin1, xmax1, ymin1, ymax1] but grid cell size [csx2, csy2]. The grid alignment module between the first and second processing stages compares the differences between the ranges and, for example, performs padding of the backbone feature map C in order to adjust its range to the range of feature map B. More specifically, the number of rasters padded for each dimension is determined as follows

$$[ \frac{{xmin}_{2} - {xmin}_{1}}{{cs}_{x 2}} \frac{{xmax}_{2} - {xmax}_{1}}{{cs}_{x 2}} \frac{{ymin}_{2} - {ymin}_{1}}{{cs}_{y 2}} \frac{{ymax}_{2} - {ymax}_{1}}{{cs}_{y 2}} ]$$

The values of cells added by padding can be set to a constant value, such as zero, or in another way. It should be noted that the padding values are integers, so that the grids can be manipulated. After the grid alignment, feature map B in the large range can be merged with the aligned feature map D for the further processing stage two. Finally, all aligned feature maps are forwarded to the feature pyramid network and the detection head for further processing.

The architecture shown and described above is a specific implementation that can be modified in many ways. A generalized basic architecture can be described as follows. The input of the network is a set of unordered points representing a point cloud from LiDAR, radar or other sensors that produce points as output. The distance adjustment can be extended to n-dimensional spatial use cases, such as the distance adjustment for 3D grid-based object recognition. The concept of distance adjustment can be extended with other point features, such as distance adjustment and point filtering on the basis of the intensity of the point. The architecture can use any type of processing before the distance adjustment. The grid projection modules can be any type of module that takes as input a list of unordered points and outputs a grid (2D, 3D or another dimension) covering a region at a given resolution. After the range adjustment, the architecture can use any type of processing, with the prerequisite of known predefined ranges. A plurality of neural networks (NNs) can be used as backbone and head, including convolutional neural networks (CNNs), transformer architectures, etc. Output formats other than oriented bounding boxes are also possible, such as semantic segmentations, occupancy rasters or visibility maps.

The proposed approach can also be used in other areas. For example, the approach can be used in automatic assembly systems, e.g., for recognizing components and their orientation in order to determine the gripping point. The method can also be used in automated lawn mowers, e.g., for recognizing objects (obstacles) or occupancy. In addition, the method can be used for automatic access controls, e.g., for person recognition and identification for automatic door opening. The method can be used to monitor places or buildings, e.g., for the detection, testing and classification of dangerous goods. The method can be used for traffic monitoring with stationary radar sensors. The method can be used to recognize and classify road users in an assistance system for bicycles or other two-wheelers (motorcycles, mopeds, etc.).

Finally, it should be pointed out that terms like “having,” “comprising,” etc. do not exclude other elements or steps and terms like “a” or “an” do not exclude a plurality.

What is claimed is:

1. A method for processing sensor data, wherein the sensor data are present as a point cloud of individual points, the method comprising the following steps:
projecting the points into at least two rasters with different resolutions, wherein points from a subregion of the point cloud are projected into a first raster with higher resolution and further points of the point cloud are projected into a second raster with lower resolution; and
compressing attributes from the first raster and arranging the compressed attributes from the first raster in the second raster, before attributes from the second raster are compressed.

2. The method according to claim 1, wherein the compressed attributes from the first raster are aligned to the second raster before the compressed attributes from the first raster are arranged in the second raster.

3. The method according to claim 1, wherein the compressed attributes from the first raster are scaled to the resolution of the second raster before the compressed attributes from the first raster are arranged in the second raster.

4. The method according to claim 1, wherein the points of the subregion are also projected into the second raster and, when the compressed attributes from the first raster are arranged in the second raster, the compressed attributes from the first raster are combined with uncompressed attributes of the points from the subregion that are already present in the second raster.

5. The method according to claim 1, wherein, during the compression of the attributes of the first raster, the attributes from the first raster are compressed to the resolution of the second raster.

6. The method according to claim 1, wherein, during the projection, attributes of plurality of points are combined when the plurality of points are projected into a common cell of the relevant raster.

7. The method according to claim 1, wherein points arranged in a near range are projected into the first raster and points arranged in a far range are projected into the second raster.

8. The method according to claim 1, wherein further points of the point cloud are projected into a further raster with lower resolution, wherein attributes from the second raster are compressed into second compressed attributes and are arranged in the further raster before attributes from the further raster are compressed.

9. A control unit configured to process sensor data, wherein the sensor data are present as a point cloud of individual points, the control unit configured to:
project the points into at least two rasters with different resolutions, wherein points from a subregion of the point cloud are projected into a first raster with higher resolution and further points of the point cloud are projected into a second raster with lower resolution; and
compress attributes from the first raster and arrange the compressed attributes from the first raster in the second raster, before attributes from the second raster are compressed.

10. A non-transitory machine-readable storage medium on which is stored a computer program for processing sensor data, wherein the sensor data are present as a point cloud of individual points, the computer program, when executed by a processor, causing the processor to perform the following steps:
projecting the points into at least two rasters with different resolutions, wherein points from a subregion of the point cloud are projected into a first raster with higher resolution and further points of the point cloud are projected into a second raster with lower resolution; and
compressing attributes from the first raster and arranging the compressed attributes from the first raster in the second raster, before attributes from the second raster are compressed.
